(19) United States
(12) Patent Application Publication
(10) Pub. No.: US 2025/0336292 A1
(43) Pub. Date: Oct. 30, 2025

(54) Multi-Vehicle Cruise Control for Traversing Vehicle Transportation Network

(71) Applicant: Nissan North America, Inc., Franklin, TN (US)

(72) Inventors: Najamuddin Mirza BALG, San Jose, CA (US); Fang-Chieh CHOU, Sunnyvale, CA (US); Liam PEDERSEN, San Francisco, CA (US)

(21) Appl. No.: 18/429,014

(22) Filed: Jan. 31, 2024

(51) Int. Cl. G08G 1/0967

(52) U.S. Cl. CPC G08G 1/096725

(57) ABSTRACT

Collective action by multiple vehicles traversing a vehicle transportation network is used to improve operation of vehicles and utilization of the vehicle transportation network. Sensor data for multiple monitored vehicles traveling in a common direction along a road in a vehicle transportation network is received and used as input to a traffic estimation model to determine an estimated congestion for the road in the common direction. A cruise control setting for each of several controlled vehicles, at least some of the controlled vehicles traveling behind the monitored vehicles in the common direction, is determined from the estimated congestion. The cruise control setting is transmitted to the controlled vehicles to modify operation of the controlled vehicles using respective cruise control systems of the controlled vehicles.

### TECHNICAL FIELD

This application relates to collective action of multiple vehicles and, more particularly, to determining cruise control settings for the multiple vehicles to traverse a vehicle transportation network.

### BACKGROUND

Vehicles, including autonomous vehicles, are conventionally operated using disparate operational data. That is, the control of an individual vehicle for traversing a vehicle transportation network is based on scene understanding by that vehicle and/or by a driver of that vehicle.

### SUMMARY

Control instructions for operating individual vehicles based on respective inputs can result in sub-optimal operation of the individual vehicles as well as sub-optimal collective operation. The teachings herein describe how the inputs from various vehicles can be used to determine collection action for vehicles that improves operation of the vehicles.

A first aspect of the disclosed implementations is an apparatus including a processor configured to repeatedly perform a control loop. In the control loop, the processor receives sensor data for multiple monitored vehicles traveling in a common direction along a road in a vehicle transportation network, determines, using the sensor data as input to a traffic estimation model, an estimated congestion for the road in the common direction, determines, from the estimated congestion, a cruise control setting for each of several controlled vehicles, at least some of the controlled vehicles traveling behind the monitored vehicles in the common direction, and transmits, to the controlled vehicles, the cruise control setting to modify operation of the controlled vehicles using respective cruise control systems of the controlled vehicles. A second aspect of the disclosed implementations is a method including repeatedly performing a control loop. The control loop includes receiving sensor data for multiple monitored vehicles traveling in a common direction along a road in a vehicle transportation network, determining, using the sensor data as input to a traffic estimation model, an estimated congestion for the road in the common direction, determining, from the estimated congestion, a cruise control setting for each of several controlled vehicles, at least some of the controlled vehicles traveling behind the monitored vehicles in the common direction, and transmitting, to the controlled vehicles, the cruise control setting to modify operation of the controlled vehicles using respective cruise control systems of the controlled vehicles.

A third aspect of the disclosed implementations is a non-transitory computer-readable medium storing instructions operable to cause one or more processors to perform operations that include repeatedly performing a control loop. The control loop includes receiving sensor data for multiple monitored vehicles traveling in a common direction along a road in a vehicle transportation network, determining, using the sensor data as input to a traffic estimation model, an estimated congestion for the road in the common direction, determining, from the estimated congestion, a cruise control setting for each of several controlled vehicles, at least some of the controlled vehicles traveling behind the monitored vehicles in the common direction, and transmitting instructions to the controlled vehicles. The instructions include the cruise control setting to modify operation of the controlled vehicles using respective cruise control systems of the controlled vehicles.

Variations in these and other aspects, features, elements, implementations, and embodiments of the methods, apparatus, procedures, and algorithms disclosed herein are described in further detail hereafter.

### BRIEF DESCRIPTION OF THE DRAWINGS

The disclosed technology is best understood from the following detailed description when read in conjunction with the accompanying drawings. It is emphasized that, according to common practice, the various features of the drawings may not be to scale. On the contrary, the dimensions of the various features may be arbitrarily expanded or reduced for clarity. Further, like reference numbers refer to like elements throughout the drawings unless otherwise noted.

FIG. 1 is a diagram of an example of a portion of a vehicle in which the aspects, features, and elements disclosed herein may be implemented.

FIG. 2 is a diagram of an example of a portion of a vehicle transportation and communication system in which the aspects, features, and elements disclosed herein may be implemented.

FIG. 3 is a flowchart diagram of an example of a process for using multi-vehicle cruise control to traverse a vehicle transportation network according to implementations of this disclosure.

FIG. 4 is a diagram illustrating examples of the monitored vehicles from which data is received and examples of the controlled vehicles according to FIG. 3.

FIG. 5 is a diagram illustrating data of the traffic estimation model used in the process of FIG. 3.

FIG. 6 is a diagram illustrating a training algorithm of a controller for use in the process of FIG. 3.

FIG. 7 is a diagram of a control loop of the process of FIG. 3 relative to a control loop of the adaptive cruise control system of a controlled vehicle.

FIGS. 8A, 8B, and 8C are graphs respectively illustrating fuel economy, travel time, and throughput of a road compared to the penetration rate of controlled vehicles.

### DETAILED DESCRIPTION

A vehicle (which may also be referred to herein as a host vehicle), such as an autonomous vehicle (AV) or a semi-autonomous vehicle that includes an advanced driver-assistance system (ADAS), may traverse a portion of a vehicle transportation network using information derived from sensors. Traversing the vehicle transportation network may include the sensors generating or capturing sensor data, such as data corresponding to an operational environment of the vehicle, or a portion thereof. For example, the sensor data may include data corresponding to one or more external objects (or simply, objects) including other (i.e., other than the host vehicle itself) road users (such as other vehicles, bicycles, motorcycles, trucks, etc.) that may also be traversing the vehicle transportation network.

Control of the operation of the vehicle is based on the individual sensor data. Controlling individual vehicles based on their respective sensor data can result in sub-optimal operation of vehicles and sub-optimal utilization of the vehicle transportation network. Considering the effect of this vehicle operation on multiple other vehicles can be used to collectively modify vehicle behavior to improve vehicle operation and network utilization.

To describe some implementations of the teachings herein in greater detail, reference is first made to the environment in which this disclosure may be implemented.

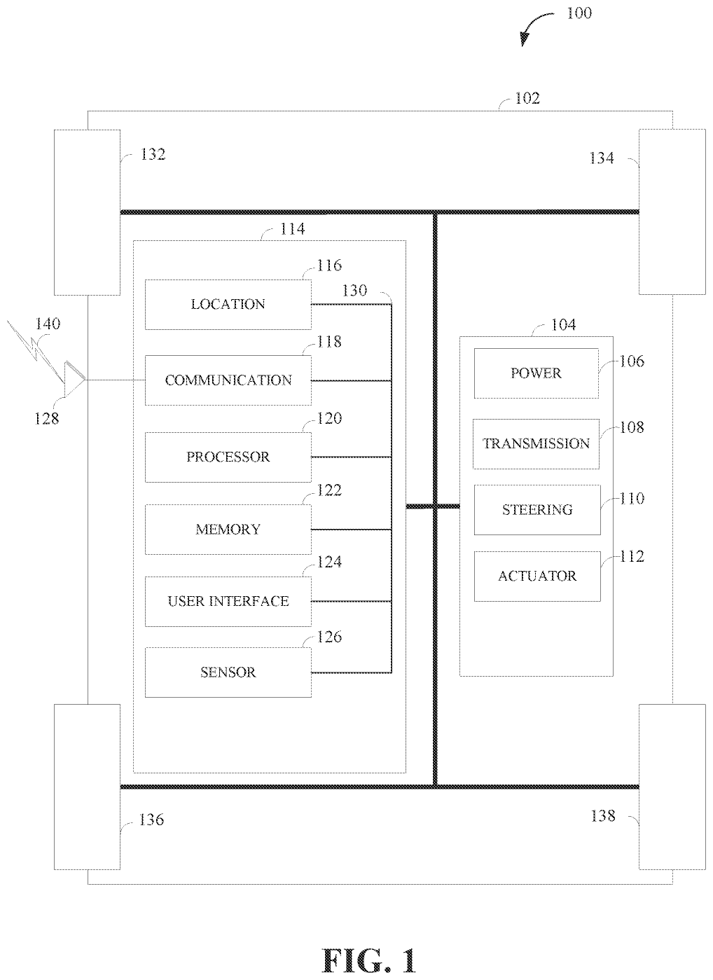

FIG. 1 is a diagram of an example of a portion of a vehicle 100 in which the aspects, features, and elements disclosed herein may be implemented. The vehicle 100 includes a chassis 102, a powertrain 104, a controller 114, wheels 132/134/136/138, and may include any other element or combination of elements of a vehicle. Although the vehicle 100 is shown as including four wheels 132/134/136/138 for simplicity, any other propulsion device or devices, such as a propeller or tread, may be used. In FIG. 1, the lines interconnecting elements, such as the powertrain 104, the controller 114, and the wheels 132/134/136/138, indicate that information, such as data or control signals, power, such as electrical power or torque, or both information and power, may be communicated between the respective elements. For example, the controller 114 may receive power from the powertrain 104 and communicate with the powertrain 104, the wheels 132/134/136/138, or both, to control the vehicle 100, which can include accelerating, decelerating, steering, or otherwise controlling the vehicle 100.

The powertrain 104 includes a power source 106, a transmission 108, a steering unit 110, a vehicle actuator 112, and may include any other element or combination of elements of a powertrain, such as a suspension, a drive shaft, axles, or an exhaust system. Although shown separately, the wheels 132/134/136/138 may be included in the powertrain 104.

The power source 106 may be any device or combination of devices operative to provide energy, such as electrical energy, thermal energy, or kinetic energy. For example, the power source 106 includes an engine, such as an internal combustion engine, an electric motor, or a combination of an internal combustion engine and an electric motor, and is operative to provide kinetic energy as a motive force to one or more of the wheels 132/134/136/138. In some embodiments, the power source 106 includes a potential energy unit, such as one or more dry cell batteries, such as nickel-cadmium (NiCd), nickel-zinc (NiZn), nickel metal hydride (NiMH), lithium-ion (Li-ion); solar cells; fuel cells; or any other device capable of providing energy.

The transmission 108 receives energy, such as kinetic energy, from the power source 106 and transmits the energy to the wheels 132/134/136/138 to provide a motive force. The transmission 108 may be controlled by the controller 114, the vehicle actuator 112, or both. The steering unit 110 may be controlled by the controller 114, the vehicle actuator 112, or both and controls the wheels 132/134/136/138 to steer the vehicle. The vehicle actuator 112 may receive signals from the controller 114 and may actuate or control the power source 106, the transmission 108, the steering unit 110, or any combination thereof to operate the vehicle 100.

In the illustrated embodiment, the controller 114 includes a location unit 116, an electronic communication unit 118, a processor 120, a memory 122, a user interface 124, a sensor 126, and an electronic communication interface 128. Although shown as a single unit, any one or more elements of the controller 114 may be integrated into any number of separate physical units. For example, the user interface 124 and the processor 120 may be integrated in a first physical unit, and the memory 122 may be integrated in a second physical unit. Although not shown in FIG. 1, the controller 114 may include a power source, such as a battery. Although shown as separate elements, the location unit 116, the electronic communication unit 118, the processor 120, the memory 122, the user interface 124, the sensor 126, the electronic communication interface 128, or any combination thereof can be integrated in one or more electronic units, circuits, or chips.

In some embodiments, the processor 120 includes any device or combination of devices, now-existing or hereafter developed, capable of manipulating or processing a signal or other information, for example optical processors, quantum processors, molecular processors, or a combination thereof. For example, the processor 120 may include one or more special-purpose processors, one or more digital signal processors, one or more microprocessors, one or more controllers, one or more microcontrollers, one or more integrated circuits, one or more Application Specific Integrated Circuits, one or more Field Programmable Gate Arrays, one or more programmable logic arrays, one or more programmable logic controllers, one or more state machines, or any combination thereof. The processor 120 may be operatively coupled with the location unit 116, the memory 122, the electronic communication interface 128, the electronic communication unit 118, the user interface 124, the sensor 126, the powertrain 104, or any combination thereof. For example, the processor may be operatively coupled with the memory 122 via a communication bus 130.

The processor 120 may be configured to execute instructions. Such instructions may include instructions for remote operation, which may be used to operate the vehicle 100 from a remote location, including the operations center. The instructions for remote operation may be stored in the vehicle 100 or received from an external source, such as a traffic management center, or server computing devices, which may include cloud-based server computing devices.

The memory 122 may include any tangible non-transitory computer-usable or computer-readable medium capable of, for example, containing, storing, communicating, or transporting machine-readable instructions or any information associated therewith, for use by or in connection with the processor 120. The memory 122 may include, for example, one or more solid state drives, one or more memory cards, one or more removable media, one or more read-only memories (ROM), one or more random-access memories (RAM), one or more registers, one or more low power double data rate (LPDDR) memories, one or more cache memories, one or more disks (including a hard disk, a floppy disk, or an optical disk), a magnetic or optical card, or any type of non-transitory media suitable for storing electronic information, or any combination thereof.

The electronic communication interface 128 may be a wireless antenna, as shown, a wired communication port, an optical communication port, or any other wired or wireless unit capable of interfacing with a wired or wireless electronic communication medium 140.

The electronic communication unit 118 may be configured to transmit or receive signals via the wired or wireless electronic communication medium 140, such as via the electronic communication interface 128. Although not explicitly shown in FIG. 1, the electronic communication unit 118 is configured to transmit, receive, or both via any wired or wireless communication medium, such as radio frequency (RF), ultra violet (UV), visible light, fiber optic, wire line, or a combination thereof. Although FIG. 1 shows a single one of the electronic communication unit 118 and a single one of the electronic communication interface 128, any number of communication units and any number of communication interfaces may be used. In some embodiments, the electronic communication unit 118 can include a dedicated short-range communications (DSRC) unit, a wireless safety unit (WSU), IEEE 802.11p (WiFi-P), or a combination thereof.

The location unit 116 may determine geolocation information, including but not limited to longitude, latitude, elevation, direction of travel, or speed, of the vehicle 100. For example, the location unit includes a global positioning system (GPS) unit, such as a Wide Area Augmentation System (WAAS) enabled National Marine Electronics Association (NMEA) unit, a radio triangulation unit, or a combination thereof. The location unit 116 can be used to obtain information that represents, for example, a current heading of the vehicle 100, a current position of the vehicle 100 in two or three dimensions, a current angular orientation of the vehicle 100, or a combination thereof.

The user interface 124 may include any unit capable of being used as an interface by a person, including any of a virtual keypad, a physical keypad, a touchpad, a display, a touchscreen, a speaker, a microphone, a video camera, a sensor, and a printer. The user interface 124 may be operatively coupled with the processor 120, as shown, or with any other element of the controller 114. Although shown as a single unit, the user interface 124 can include one or more physical units. For example, the user interface 124 includes an audio interface for performing audio communication with a person, and a touch display for performing visual and touch-based communication with the person.

The sensor 126 may include one or more sensors, such as an array of sensors, which may be operable to provide information that may be used to control the vehicle. The sensor 126 can provide information regarding current operating characteristics of the vehicle or its surroundings. The sensor 126 includes, for example, a speed sensor, acceleration sensors, a steering angle sensor, traction-related sensors, braking-related sensors, or any sensor, or combination of sensors, that is operable to report information regarding some aspect of the current dynamic situation of the vehicle 100.

In some embodiments, the sensor 126 includes sensors that are operable to obtain information regarding the physical environment surrounding the vehicle 100. For example, one or more sensors detect road geometry and obstacles, such as fixed obstacles, vehicles, cyclists, and pedestrians. The sensor 126 can be or include one or more video cameras, laser-sensing systems, infrared-sensing systems, acoustic-sensing systems, or any other suitable type of on-vehicle environmental sensing device, or combination of devices, now known or later developed. The sensor 126 and the location unit 116 may be combined.

Although not shown separately, the vehicle 100 may include a trajectory controller. For example, the controller 114 may include a trajectory controller. The trajectory controller may be operable to obtain information describing a current state of the vehicle 100 and a route planned for the vehicle 100, and, based on this information, to determine and optimize a trajectory for the vehicle 100. In some embodiments, the trajectory controller outputs signals operable to control the vehicle 100 such that the vehicle 100 follows the trajectory that is determined by the trajectory controller. For example, the output of the trajectory controller can be an optimized trajectory that may be supplied to the powertrain 104, the wheels 132/134/136/138, or both. The optimized trajectory can be a control input, such as a set of steering angles, with each steering angle corresponding to a point in time or a position. The optimized trajectory can be one or more paths, lines, curves, or a combination thereof.

One or more of the wheels 132/134/136/138 may be a steered wheel, which is pivoted to a steering angle under control of the steering unit 110; a propelled wheel, which is torqued to propel the vehicle 100 under control of the transmission 108; or a steered and propelled wheel that steers and propels the vehicle 100.

A vehicle may include units or elements not shown in FIG. 1, such as an enclosure, a Bluetooth® module, a frequency modulated (FM) radio unit, a Near-Field Communication (NFC) module, a liquid crystal display (LCD) display unit, an organic light-emitting diode (OLED) display unit, a speaker, or any combination thereof.

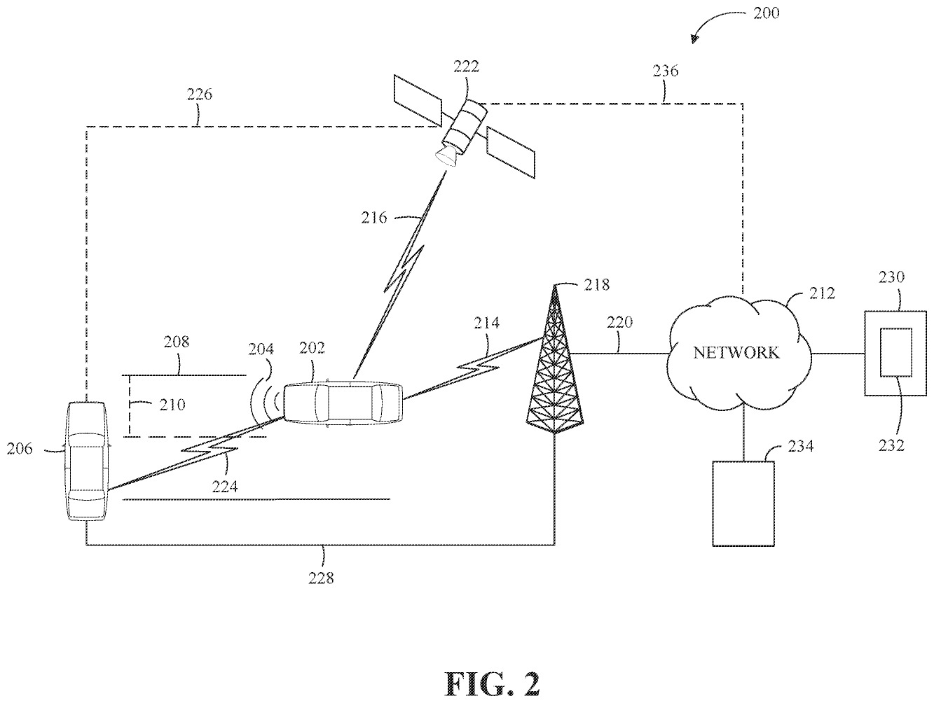

FIG. 2 is a diagram of an example of a portion of a vehicle transportation and communication system 200 in which the aspects, features, and elements disclosed herein may be implemented. The vehicle transportation and communication system 200 includes a vehicle 202, such as the vehicle 100 shown in FIG. 1, and one or more external objects, such as an external object 206, which can include any form of transportation, such as the vehicle 100 shown in FIG. 1, a pedestrian, cyclist, as well as any form of a structure, such as a building. The vehicle 202 may travel via one or more portions of a transportation network 208, and may communicate with the external object 206 via one or more of an electronic communication network 212. Although not explicitly shown in FIG. 2, a vehicle may traverse an area that is not expressly or completely included in a transportation network, such as an off-road area. In some embodiments, the transportation network 208 may include one or more of a vehicle detection sensor 210, such as an inductive loop sensor, which may be used to detect the movement of vehicles on the transportation network 208.

The electronic communication network 212 may be a multiple access system that provides for communication, such as voice communication, data communication, video communication, messaging communication, or a combination thereof, between the vehicle 202, the external object 206, and an operations center 230. For example, the vehicle 202 or the external object 206 may receive information, such as information representing the transportation network 208, from the operations center 230 via the electronic communication network 212.

The operations center 230 includes a controller apparatus 232, which includes some or all of the features of the controller 114 shown in FIG. 1. The controller apparatus 232 can monitor and coordinate the movement of vehicles, including autonomous vehicles. The controller apparatus 232 may monitor the state or condition of vehicles, such as the vehicle 202, and external objects, such as the external object 206. The controller apparatus 232 can receive vehicle data and infrastructure data including any of: vehicle velocity; vehicle location; vehicle operational state; vehicle destination; vehicle route; vehicle sensor data; external object velocity; external object location; external object operational state; external object destination; external object route; and external object sensor data.

Further, the controller apparatus 232 can establish remote control over one or more vehicles, such as the vehicle 202, or external objects, such as the external object 206. In this way, the controller apparatus 232 may teleoperate the vehicles or external objects from a remote location. The controller apparatus 232 may exchange (send or receive) state data with vehicles, external objects, or a computing device, such as the vehicle 202, the external object 206, or a server computing device 234, via a wireless communication link, such as the wireless communication link 226, or a wired communication link, such as the wired communication link 228.

The server computing device 234 may include one or more server computing devices, which may exchange (send or receive) state signal data with one or more vehicles or computing devices, including the vehicle 202, the external object 206, or the operations center 230, via the electronic communication network 212.

In some embodiments, the vehicle 202 or the external object 206 communicates via the wired communication link 228, a wireless communication link 214/216/224, or a combination of any number or types of wired or wireless communication links. For example, as shown, the vehicle 202 or the external object 206 communicates via a terrestrial wireless communication link 214, via a non-terrestrial wireless communication link 216, or via a combination thereof. In some implementations, a terrestrial wireless communication link 214 includes an Ethernet link, a serial link, a Bluetooth link, an infrared (IR) link, an ultraviolet (UV) link, or any link capable of electronic communication.

A vehicle, such as the vehicle 202, or an external object, such as the external object 206, may communicate with another vehicle, external object, or the operations center 230. For example, a host, or subject, vehicle 202 may receive one or more automated inter-vehicle messages, such as a basic safety message (BSM), from the operations center 230 via a direct communication link 224 or via an electronic communication network 212. For example, the operations center 230 may broadcast the message to host vehicles within a defined broadcast range, such as three hundred meters, or to a defined geographical area. In some embodiments, the vehicle 202 receives a message via a third party, such as a signal repeater (not shown) or another remote vehicle (not shown). In some embodiments, the vehicle 202 or the external object 206 transmits one or more automated inter-vehicle messages periodically based on a defined interval, such as one hundred milliseconds.

The vehicle 202 may communicate with the electronic communication network 212 via an access point 218. The access point 218, which may include a computing device, is configured to communicate with the vehicle 202, with the electronic communication network 212, with the operations center 230, or with a combination thereof via wired or wireless communication links 214/220. For example, an access point 218 is a base station, a base transceiver station (BTS), a Node-B, an enhanced Node-B (eNode-B), a Home Node-B (HNode-B), a wireless router, a wired router, a hub, a relay, a switch, or any similar wired or wireless device. Although shown as a single unit, an access point can include any number of interconnected elements.

The vehicle 202 may communicate with the electronic communication network 212 via a satellite 222 or other non-terrestrial communication device. The satellite 222, which may include a computing device, may be configured to communicate with the vehicle 202, with the electronic communication network 212, with the operations center 230, or with a combination thereof via one or more communication links 216/236. Although shown as a single unit, a satellite can include any number of interconnected elements.

The electronic communication network 212 may be any type of network configured to provide for voice, data, or any other type of electronic communication. For example, the electronic communication network 212 includes a local area network (LAN), a wide area network (WAN), a virtual private network (VPN), a mobile or cellular telephone network, the Internet, or any other electronic communication system. The electronic communication network 212 may use a communication protocol, such as the Transmission Control Protocol (TCP), the User Datagram Protocol (UDP), the Internet Protocol (IP), the Real-time Transport Protocol (RTP), the Hyper Text Transport Protocol (HTTP), or a combination thereof. Although shown as a single unit, an electronic communication network can include any number of interconnected elements.

In some embodiments, the vehicle 202 communicates with the operations center 230 via the electronic communication network 212, access point 218, or satellite 222. The operations center 230 may include one or more computing devices, which are able to exchange (send or receive) data from a vehicle, such as the vehicle 202; data from external objects, including the external object 206; or data from a computing device, such as the server computing device 234.

In some embodiments, the vehicle 202 identifies a portion or condition of the transportation network 208. For example, the vehicle 202 may include one or more on-vehicle sensors 204, such as the sensor 126 shown in FIG. 1, which includes a speed sensor, a wheel speed sensor, a camera, a gyroscope, an optical sensor, a laser sensor, a radar sensor, a sonic sensor, or any other sensor or device or combination thereof capable of determining or identifying a portion or condition of the transportation network 208.

The vehicle 202 may traverse one or more portions of the transportation network 208 using information communicated via the electronic communication network 212, such as information representing the transportation network 208, information identified by one or more on-vehicle sensors 204, or a combination thereof. The external object 206 may be capable of all or some of the communications and actions described above with respect to the vehicle 202.

For simplicity, FIG. 2 shows the vehicle 202 as the host vehicle, the external object 206, the transportation network 208, the electronic communication network 212, and the operations center 230. However, any number of vehicles, networks, or computing devices may be used. In some embodiments, the vehicle transportation and communication system 200 includes devices, units, or elements not shown in FIG. 2.

Although the vehicle 202 is shown communicating with the operations center 230 via the electronic communication network 212, the vehicle 202 (and the external object 206) may communicate with the operations center 230 via any number of direct or indirect communication links. For example, the vehicle 202 or the external object 206 may communicate with the operations center 230 via a direct communication link, such as a Bluetooth communication link. Although, for simplicity, FIG. 2 shows one of the transportation network 208 and one of the electronic communication network 212, any number of networks or communication devices may be used.

The external object 206 is illustrated as a second, remote vehicle in FIG. 2. An external object is not limited to another vehicle. An external object may be any infrastructure element, for example, a fence, a sign, a building, etc., that has the ability transmit data to the operations center 230. The data may be, for example, sensor data from the infrastructure element.

Regardless of the sensor source, each vehicle traveling in the vehicle transportation network determines its (e.g., optimal) operation based on the sensed data. Collective action based on the sensed data as described herein can improve the operation of multiple vehicles and can also improve the operation of the vehicle transportation system itself.

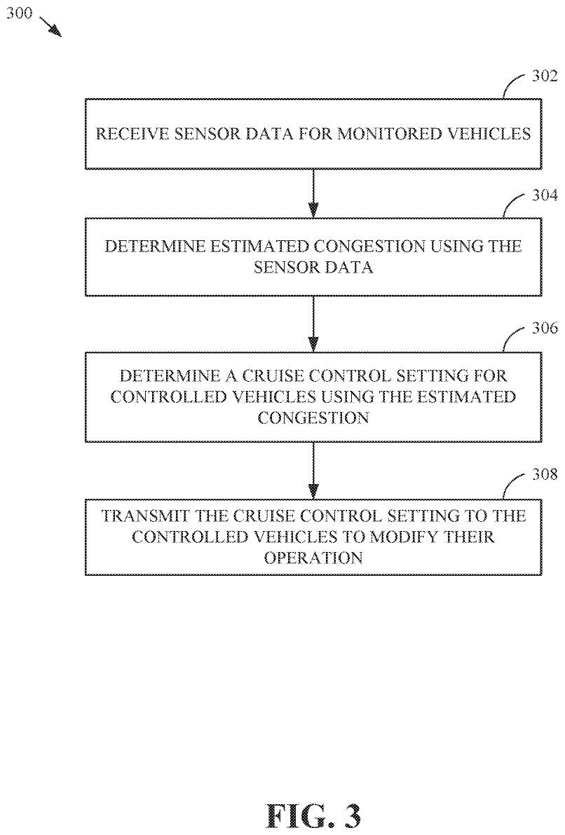

FIG. 3 is a flowchart diagram of an example of a method or process 300 for using multi-vehicle cruise control to traverse a vehicle transportation network according to implementations of this disclosure. The process 300 includes operations 302 through 308, which are described below. The process 300 can be stored in a memory as instructions that can be executed by a processor. For example, the operations of the process 300 may be performed at a remote support center for vehicle, such as by the controller apparatus 232 at the operations center 230.

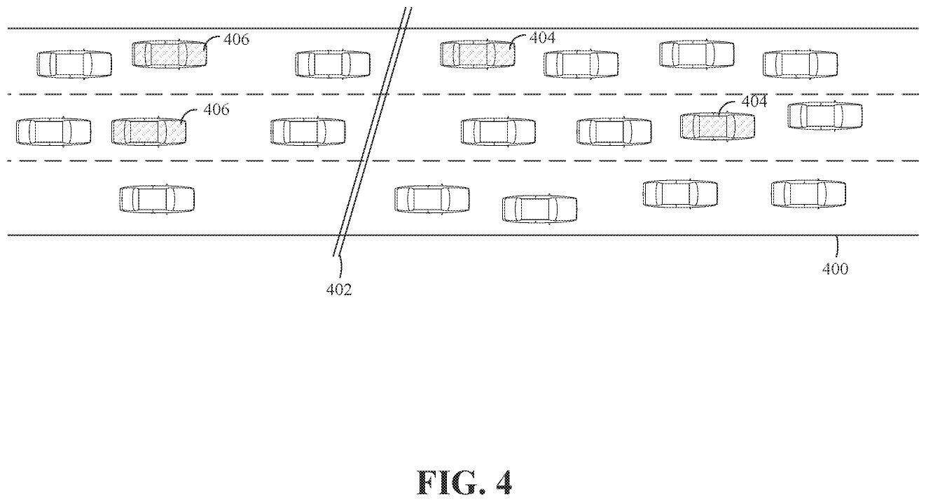

At operation 302, the process 300 receives sensor data for multiple monitored vehicles. In an implementation, the monitored vehicles are traveling in a common direction along a road in the vehicle transportation network. This can be explained with reference to FIG. 4, which is a diagram illustrating examples of the monitored vehicles 404 from which data is received and examples of the controlled vehicles 406 discussed later.

The road 400 in FIG. 4 has multiple lanes along which the monitored vehicles 404 travel in the common direction. More specifically, the road 400 is a multi-lane highway along which vehicles travel from left to right. The double lines 402 indicate that one or more sections or segments of the road 400 between the forward segment and the subsequent segment are omitted. The sensor data can be received for the monitored vehicles 404. The sensor data can be obtained from a location unit, such as the location unit 116, and one or more sensors, such as the sensor 126, of a respective monitored vehicle 404. The sensor data can be communicated through a (e.g., wireless) communication unit, such as the communication unit 118. In some implementations, the sensor data can be a GPS signal, a speed, a radar signal, or any combination thereof, e.g., from each of the monitored vehicles 404. Other sensor data, or data developed from sensor data, can be received, such as acceleration/deceleration data.

As can be seen from FIG. 4, sensor data may be received from only some vehicles traveling along the road 400. These monitored vehicles 404 may be referred to generally as connected vehicles. In some implementations, sensor data identifying location, speed, etc., of the vehicles may also be obtained from sources other than the monitored vehicles, such as from infrastructure sensors described previously.

At operation 304, an estimated congestion is determined using the sensor data. More specifically, using the sensor data as input to a traffic estimation model, an estimated congestion for the road in the common direction is determined.

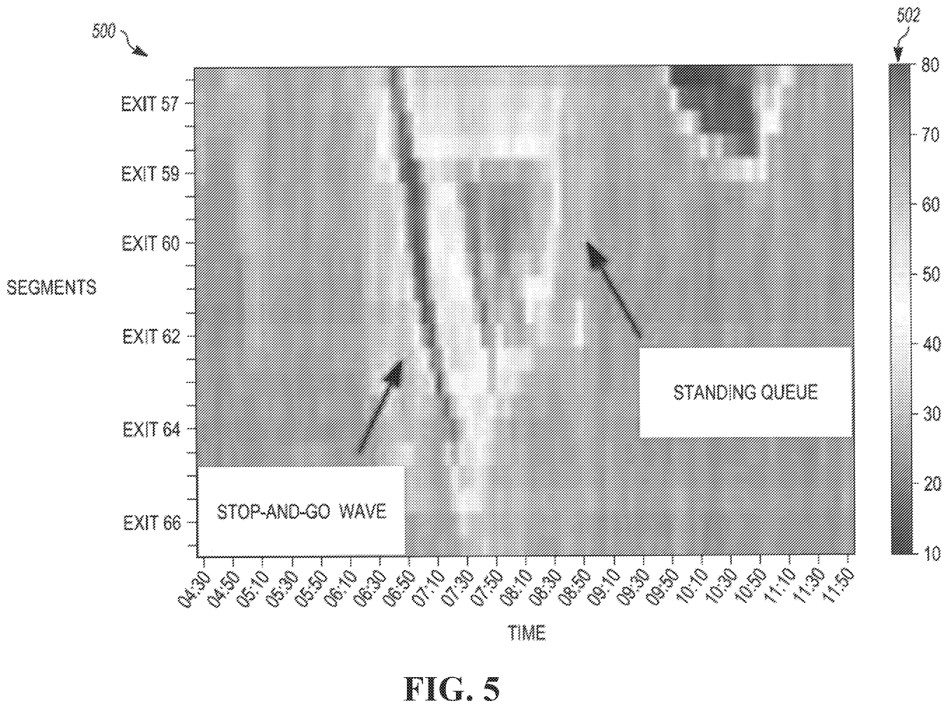

Referring to FIG. 5, a diagram illustrating data of the traffic estimation model used in the process 300 of FIG. 3 is shown. The data shown in FIG. 5 is only a portion of the data used in the traffic estimation model. The data is shown as a graph 500 of the velocity contour of a portion of a highway in one direction. Specifically, the model relates segments of the road in the common direction (along the y-axis) to a speed of vehicles within the segments over time (along the x-axis). Here, the segments are delineated by exit markers and the time step is every 5 minutes. The legend 502 indicates the speed in miles per hour (mph). FIG. 5 shows congestion over time, with arrows indicating the characteristic standing queue of a so-called traffic jam with the following stop-and-go wave(s).

Determining the estimated congestion for the road in the common direction may include determining, using the sensor data, expected speeds for segments of the road if existing operation of the controlled vehicles is maintained. For example, and referring to FIGS. 4 and 5, if the monitored vehicles 404 are exhibiting speeds at Exit 57 conforming to the graph 500, then the expected speeds for other segments of the road can be determined from the graph 500. The estimated congestion can also be indicated by the density of vehicles within a segment. The density of vehicles includes both monitored vehicles for which sensed data is received, such as the monitored vehicles 404, and any unmonitored vehicles within the segment (shown in FIG. 4 without hashing).

At operation 306, a cruise control setting for controlled vehicles is determined using the estimated congestion. For example, a cruise control setting may be determined for each of several controlled vehicles. Referring to FIG. 4, examples of several controlled vehicles 406 are shown. At least some of the controlled vehicles 406 are traveling behind the monitored vehicles 404 in the common direction. In some implementations, one or more the controlled vehicles 406 may be traveling with or adjacent to the monitored vehicles 404 for which the sensed data is obtained.

The cruise control setting may be a speed setting, a follow distance (follow distance setting), or both, for a respective vehicle of the controlled vehicles, such as the controlled vehicles 406. In some implementations, the estimated congestion (such as the estimated speeds and/or estimated density) of road segments leading up to one or more monitor segments is provided as input, and the cruise control setting can be based on in which of the segments each of the several controlled vehicles is located. That is, a cruise control setting can be determined on a per-segment basis. In other implementations, a cruise control setting can be determined on a per-vehicle basis (i.e., a setting is determined for each controlled vehicle).

Various techniques may be used to determine a cruise control setting at operation 306. A deterministic approach can be taken that maps the estimated congestion (e.g., speeds and/or density) of the monitored vehicles, such as the monitored vehicles 404, in a segment of the road, such as the road 400, to one or more cruise control settings for subsequent road segments. For example, for vehicles in road segments approaching the monitored segment, a cruise control setting can be set per segment to modify the operation of the controlled vehicles within each segment. Modifying the operation by reducing a speed, increasing a follow distance, or both, for a respective vehicle of the controlled vehicles, such as the controlled vehicles 406, allows the controlled vehicles to subtly hold back traffic (e.g., other uncontrolled vehicles). The exact settings can be determined by modeling the traffic and trying different settings that collectively increase fuel economy, decrease travel time, and/or increase throughput as discussed in more detail below.

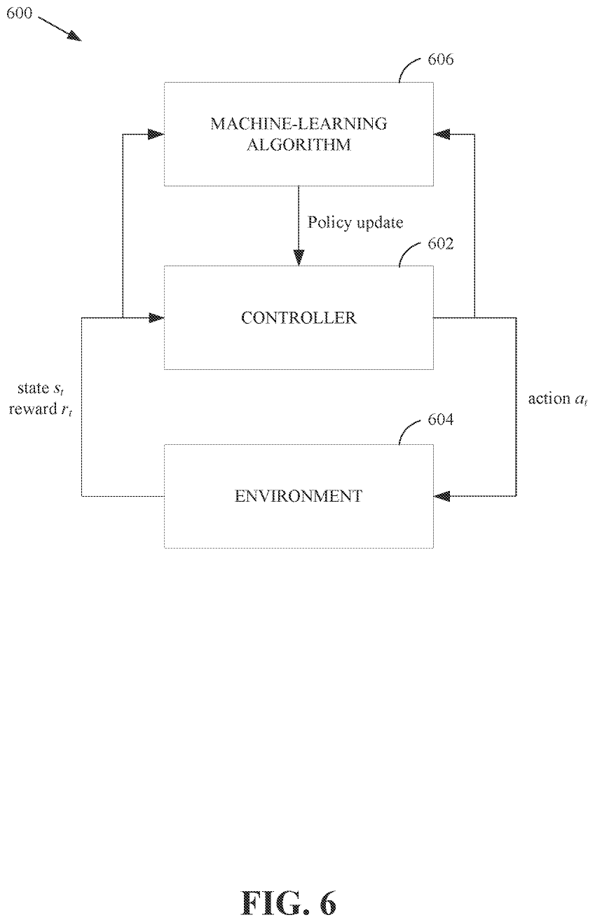

In some implementations, determining the cruise control setting for each of the controlled vehicles at operation 306 may be performed using machine-learning. In an example, one or more cruise control settings may be determined using a controller trained according to reinforcement learning. FIG. 6 is a diagram illustrating a training algorithm 600 of a controller 602 for use in the process 300 of FIG. 3.

As shown by FIG. 6, the controller 602 can be a reinforcement learning model trained by receiving a state st and a reward r, at timesteps t from simulated conditions of the road generated using the traffic estimation model. The simulated conditions are referred to as the environment 604 in FIG. 6. The simulated conditions can include a large number of simulated vehicles, such as greater than 1000 vehicles. The vehicles can include both controlled vehicles, such as the controlled vehicles 406, and multiple vehicles operated as if driven by a human (e.g., such as by a human driven car simulator). Using a current (such as an initial) policy of the (e.g., reinforcement learning model) of the controller 602, an action at is output that corresponds to a modification of operation of one or more simulated vehicles (i.e., controlled vehicles), the modification represented by a speed setting, a vehicle spacing, or both. For example, the modification can reduce the speeds of controlled vehicles within at least some of the road segments within the environment 604 over time. A machine-learning algorithm 606, in this case a reinforcement learning algorithm, updates the policy using the state st, the reward rt, and the action ar as input. The policy update is provided to the controller 602 for the next timestep t.

Regardless of whether the cruise control settings are associated with estimated congestion values using deterministic techniques or machine-learning, the association may be made to satisfy one or more defined goals for the collective action that improve operation of the vehicles, including uncontrolled vehicles. For example, fuel economy during congestion can be improved by collective action. Fuel economy can be improved by increasing throughput, and increasing throughput reduces travel time.

That is, for example, the cruise control setting determined at 306 can be one or more settings that increase a throughput of a lane of the road as compared to maintaining existing operation of the controlled vehicles, reduce a travel time in the common direction over a defined distance as compared to maintaining existing operation of the controlled vehicles, and/or increase fuel economy of vehicles traveling behind the monitored vehicles where the vehicles traveling behind the monitored vehicles include at least some vehicles other than the controlled vehicles traveling behind the monitored vehicles as shown by the example of FIG. 4.

At operation 308, the cruise control setting is transmitted to the controlled vehicles to modify their operation. The cruise control setting modifies operation of the controlled vehicles using respective cruise control systems of the controlled vehicles, such as the controlled vehicles 404. The cruise control systems can be conventional cruise control systems or adaptive cruise control (ACC) systems, or some combination thereof. For example, where a controlled vehicle includes an ACC system, the cruise control setting can be a speed setting that, e.g., modifies the operation of the controlled vehicle by reducing a speed of the controlled vehicle and/or a follow distance setting that, e.g., increases a follow distance for the controlled vehicle. A setting to change the lane of a vehicle may also be sent in addition to or instead of the cruise control setting.

The controlled vehicles can include at least one autonomous vehicle. In some implementations, the cruise control setting can be transmitted as an instruction to an autonomous vehicle for action by its controller and/or to a remote-controlled vehicle, i.e., a vehicle directly controlled by remote vehicle support described previously. In some implementations, a portion of the controlled vehicles can include human-driven vehicles provided with the cruise control setting as an instruction for the operator to implement in the cruise control system.

The cruise control setting and/or a lane change instruction to controlled vehicles can be transmitted over a cellular network. In an example, the method, technique, or process 300 may be performed at architecture located for multi-access edge computing such as described in US Patent Publication No. 2023/0245564 A1, which is incorporated herein in its entirety by reference, such that the transmission at operation 308 occurs over a cellular network. Other wireless communications may be used to transmit instructions at operation 308.

The operations 302 through 308 form a control loop that is repeatedly performed for a defined time period or a defined length of the road. FIG. 5 is a diagram of the control loop of the process 300 of FIG. 3 relative to a control loop of the ACC system 700 of a controlled vehicle 406. The control loop of the process 300 that transmits the cruise control setting 702 to the ACC system 700 is the outer loop, while the control loop of the ACC system 700 of the controlled vehicle 406 is the inner loop. This represents the relative cycle times of the two control loops. A cycle time of the control loop is slower than a cycle time of the ACC control loop. For example, the ACC control loop may operate at a frequency of about 100 Hertz (Hz), while the control loop of operations 302 through 308 operates at a frequency of about 0.1 Hz.

Although the description herein refers generally to transmitting instructions at operation 308 to controlled vehicles, transmitting instructions such as a modified cruise control setting or a change in lane may also be used with unconnected (uncontrolled, non-controlled) vehicles and vehicles that could be controlled but are being manually operated at the time of transmitting the instructions. An unconnected vehicle, for example, could be a vehicle that is not capable of wireless communications or is capable of wireless communication other than that used for transmitting at operation 308. In such examples, transmitting at operation 308 may include transmitting the cruise control setting, the lane change instruction, or both, to (e.g., a cellular-enabled device of) an operator of an unconnected vehicle traveling behind the monitored vehicle for the operator to modify operation of the unconnected vehicle. Doing so can improve the density of vehicles (e.g., the penetration rate) of vehicles within the vehicle transportation system and thus further improve outcomes of applying the teachings herein as described below.

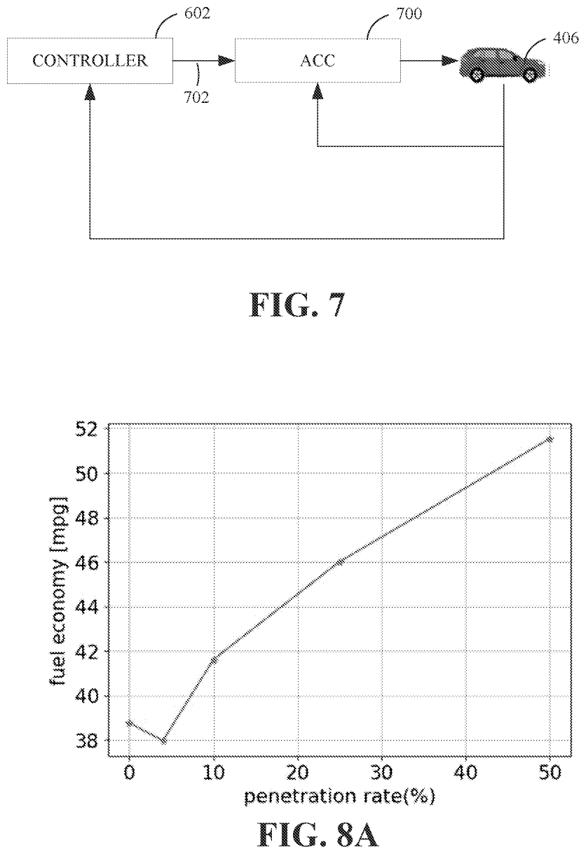

Although the process 300 is described with distinct sets of monitored vehicles, for example the monitored vehicles 404, and controlled vehicles 406, this is not required. As shown in FIG. 7, the controlled vehicles 406 can also be sources of sensed data for a subsequent iteration of the process 300. That is, a controlled vehicle 406 can be used in the subsequent iteration as one of the monitored vehicles 404. In this way, real-time monitoring can be used to update cruise control settings over time and in response to the changes caused by earlier iterations of the process 300.

Simulations were performed to show the results of the collective action with differing levels of penetration of controlled vehicles. FIGS. 7A, 7B, and 7C are graphs respectively illustrating fuel economy, travel time, and throughput of a road compared to the penetration rate of controlled vehicles. The penetration rate here is a percentage (%) of controlled vehicles to the total number of vehicles. Unconnected vehicles acting in accordance with the instructions based on operator actions would increase the penetration rate but may not show as much of an improvement due to operator delays in implementing the instructions.

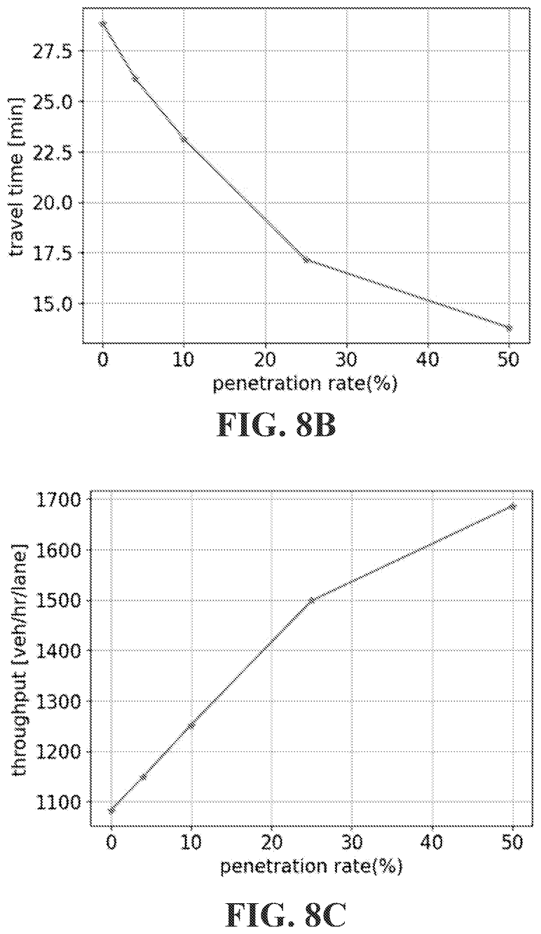

As can be seen from FIG. 8A, after an initial decrease in fuel economy in miles per gallon (mpg), the fuel economy increases as a penetration rate of the controlled vehicles on the road increases. The initial decrease may be attributed to the increase in fuel usage resulting from the addition of the controlled vehicles to a baseline number of existing vehicles.

FIG. 8B shows that the travel time in minutes (min) decreases as a penetration rate of the controlled vehicles on the road increases. The travel time is measured over 8.4 miles (14 kilometers), which has a free flow travel time of 8 minutes.

FIG. 8C shows that the throughout in vehicles per hour per lane (veh/hr/lane) increases as a penetration rate of the controlled vehicles on the road increases. The maximum throughput is 2000 veh/hr/lane.

Conventionally, the control of an individual vehicle while traversing a vehicle transportation network is based on scene understanding (including sensor data) by that vehicle and/or by a driver of that vehicle. By using sensor data from multiple monitored vehicles as disclosed herein, a number of vehicles can be collectively controlled to improve operation of vehicles in a vehicle transportation system, including uncontrolled and/or unconnected vehicles. The collective action can improve operation of the vehicle transportation system itself.

The collective action described herein can be a service offered to government entities, such as cities and municipalities, or other entities, such as fleet operators, to improve operation within a vehicle transportation system. For the government entities, the teachings herein may reduce and/or delay the need to invest in infrastructure by reducing traffic congestion. Moreover, the reduction in fuel can provide an improvement to air quality. Individual users (e.g., drivers or operators of vehicles) may also find the teachings herein useful to, for example, reduce the time they spend in traffic and/or reduce fuel costs (e.g., due to the increase in average gasoline or diesel mpg).

For simplicity of explanation, each technique herein is depicted and described as a series of operations. However, the operations in accordance with this disclosure can occur in various orders and/or concurrently. Additionally, other steps or operations not presented and described herein may be used. Furthermore, not all illustrated operations may be required to implement a technique in accordance with the disclosed subject matter.

As used herein, the terminology “driver” or “operator” may be used interchangeably. As used herein, the terminology “brake” or “decelerate” may be used interchangeably. As used herein, the terminology “computer” or “computing device” includes any unit, or combination of units, capable of performing any method, or any portion or portions thereof, disclosed herein.

As used herein, the terminology “instructions” may include directions or expressions for performing any method, or any portion or portions thereof, disclosed herein, and may be realized in hardware, software, or any combination thereof. For example, instructions may be implemented as information, such as a computer program, stored in memory that may be executed by a processor to perform any of the respective methods, algorithms, aspects, or combinations thereof, as described herein. In some implementations, instructions, or a portion thereof, may be implemented as a special-purpose processor or circuitry that may include specialized hardware for carrying out any of the methods, algorithms, aspects, or combinations thereof, as described herein. In some implementations, portions of the instructions may be distributed across multiple processors on a single device, or on multiple devices, which may communicate directly or across a network, such as a local area network, a wide area network, the Internet, or a combination thereof.

As used herein, the terminology “example,” “embodiment,” “implementation,” “aspect,” “feature,” or “element” indicate serving as an example, instance, or illustration. Unless expressly indicated otherwise, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “determine” and “identify,” or any variations thereof, includes selecting, ascertaining, computing, looking up, receiving, determining, establishing, obtaining, or otherwise identifying or determining in any manner whatsoever using one or more of the devices shown and described herein.

As used herein, the terminology “or” is intended to mean an inclusive “or” rather than an exclusive “or.” That is, unless specified otherwise or clearly indicated otherwise by the context, “X includes A or B” is intended to indicate any of the natural inclusive permutations thereof. If X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from the context to be directed to a singular form.

Further, for simplicity of explanation, although the figures and descriptions herein may include sequences or series of operations or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure. Although aspects, features, and elements are described herein in particular combinations, each aspect, feature, or element may be used independently or in various combinations with or without other aspects, features, and/or elements.

While the disclosed technology has been described in connection with certain embodiments, it is to be understood that the disclosed technology is not to be limited to the disclosed embodiments but, on the contrary, is intended to cover various modifications and equivalent arrangements included within the scope of the appended claims, which scope is to be accorded the broadest interpretation as is permitted under the law so as to encompass all such modifications and equivalent arrangements.

What is claimed is:

1. An apparatus, comprising:
a processor configured to repeatedly perform a control loop including to:
receive sensor data for monitored vehicles traveling in a common direction along a road in a vehicle transportation network;
determine, using the sensor data as input to a traffic estimation model, an estimated congestion for the road in the common direction;
determine, from the estimated congestion, a cruise control setting for each of several controlled vehicles, at least some of the controlled vehicles traveling behind the monitored vehicles in the common direction; and
transmit, to the controlled vehicles, the cruise control setting to modify operation of the controlled vehicles using respective cruise control systems of the controlled vehicles.

2. The apparatus of claim 1, wherein the respective cruise control systems are respective adaptive cruise control systems, and the cruise control setting comprises at least one of a speed setting or a follow distance setting for a respective vehicle of the controlled vehicles.

3. The apparatus of claim 1, wherein the sensor data comprises at least one of a Global Positioning System signal, a speed signal, or a radar signal from each of the monitored vehicles.

4. The apparatus of claim 1, wherein the road comprises multiple lanes along which the monitored vehicles travel in the common direction.

5. The apparatus of claim 1, wherein a cycle time of the control loop is slower than a cycle time of the respective cruise control systems.

6. The apparatus of claim 1, wherein to determine the cruise control setting for each of the controlled vehicles comprises to determine the cruise control setting to increase a throughput of each lane of the road as compared to maintaining existing operation of the controlled vehicles.

7. The apparatus of claim 6, wherein the throughout increases as a penetration rate of the controlled vehicles on the road increases.

8. The apparatus of claim 1, wherein to determine the cruise control setting for each of the controlled vehicles comprises to determine the cruise control setting to reduce a travel time in the common direction over a defined distance as compared to maintaining existing operation of the controlled vehicles.

9. The apparatus of claim 8, wherein the travel time decreases as a penetration rate of the controlled vehicles on the road increases.

10. The apparatus of claim 1, wherein to determine the cruise control setting for each of the controlled vehicles comprises to determine the cruise control setting to increase fuel economy of vehicles traveling behind the monitored vehicles, the vehicles including the at least some of the controlled vehicles traveling behind the monitored vehicles.

11. The apparatus of claim 10, wherein the fuel economy increases as a penetration rate of the controlled vehicles on the road increases.

12. The apparatus of claim 1, wherein to transmit the cruise control setting comprises to transmit the cruise control setting using a cellular network and multi-access edge computing.

13. A method, comprising:
repeatedly performing a control loop that includes:
receiving sensor data for multiple monitored vehicles traveling in a common direction along a road in a vehicle transportation network;
determining, using the sensor data as input to a traffic estimation model, an estimated congestion for the road in the common direction;
determining, from the estimated congestion, a cruise control setting for each of several controlled vehicles, at least some of the controlled vehicles traveling behind the monitored vehicles in the common direction; and
transmitting, to the controlled vehicles, the cruise control setting to modify operation of the controlled vehicles using respective cruise control systems of the controlled vehicles.

14. The method of claim 13, wherein the respective cruise control systems comprise respective adaptive cruise control systems, and the cruise control setting modifies the operation of the controlled vehicles by at least one of reducing a speed or increasing a follow distance for a respective vehicle of the controlled vehicles.

15. The method of claim 13, wherein the traffic estimation model relates segments of the road in the common direction to a speed of vehicles within the segments over time.

16. The method of claim 15, wherein transmitting the cruise control setting comprises transmitting the cruise control setting to the controlled vehicles over a cellular network, and the method comprises:
transmitting the cruise control setting to a cellular-enabled device of an operator of an unconnected vehicle traveling behind the monitored vehicle for the operator to modify operation of the unconnected vehicle.

17. The method of claim 15, wherein determining the estimated congestion for the road in the common direction comprises determining, using the sensor data, expected speeds for the segments of the road if existing operation of the controlled vehicles is maintained.

18. The method of claim 17, wherein determining the cruise control setting for each of several controlled vehicles comprises determining the cruise control setting using a controller, the controller comprising a reinforcement learning model receiving the expected speeds and the segments as input and outputting the cruise control setting based on in which of the segments each of the several controlled vehicles is located.

19. The method of claim 13, wherein the controlled vehicles comprise at least one autonomous vehicle.

20. A non-transitory storage medium that stores instructions for operations by one or more processors, the operations comprising:
repeatedly performing a control loop that includes:
receiving sensor data for multiple monitored vehicles traveling in a common direction along a road in a vehicle transportation network;
determining, using the sensor data as input to a traffic estimation model, an estimated congestion for the road in the common direction;
determining, from the estimated congestion, a cruise control setting for each of several controlled vehicles, at least some of the controlled vehicles traveling behind the monitored vehicles in the common direction; and
transmitting instructions to the controlled vehicles, the instructions comprising the cruise control setting to modify operation of the controlled vehicles using respective cruise control systems of the controlled vehicles.
